(19) United States
(12) Patent Application Publication
(10) Pub. No.: US 2024/0278596 A1
(43) Pub. Date: Aug. 22, 2024

(54) VEHICLE WHEEL HUB COVER, VEHICLE WHEEL, POWERED VEHICLE, AND METHOD OF MANUFACTURE

(71) Applicant: HOWMET AEROSPACE INC., Pittsburgh, PA (US)

(72) Inventors: Douglas P. Mason, Livonia, MI (US); Spencer Wallace, Broadview Heights, OH (US)

(21) Appl. No.: 18/570,114

(22) PCT Filed: Jul. 14, 2021
(86) PCT No.: PCT/US2021/041688

§ 371 Date: Dec. 14, 2023

(51) Int. Cl. B60B 7/00; B60B 7/02; B60B 7/06

(52) U.S. Cl. CPC B60B 7/0066; B60B 7/0013; B60B 7/02; B60B 7/068; B60B 2900/1216

(57) ABSTRACT

The present disclosure relates to a vehicle wheel hub cover, a vehicle wheel, a powered vehicle, and a related method of manufacture. The vehicle wheel hub cover comprises a first curved region and at least two protrusions radially disposed about a periphery of the first curved region. Each of the at least two protrusions comprises a first end, a second end, an elongate portion extending from the first end to the second end, and an inner surface defining a cavity configured to receive a lug of a vehicle wheel. The first ends of each of the at least two protrusions are disposed within a plane. The first curved region extends radially inwardly from a first location on each of the elongate portions of the at least two protrusions and towards the plane.

### FIELD OF USE

The present disclosure relates to a vehicle wheel hub cover, a vehicle wheel, a powered vehicle, and a related method of manufacture.

### BACKGROUND

Vehicle wheels can affect the aerodynamics of a vehicle and thereby impact fuel mileage during operation of the vehicle. Improving vehicle aerodynamics to enhance vehicle fuel mileage present challenges.

### SUMMARY

According to one aspect of the present disclosure, a vehicle wheel hub cover is provided. The vehicle wheel hub cover comprises a first curved region and at least two protrusions radially disposed about a periphery of the first curved region. Each of the at least two protrusions comprises a first end, a second end, an elongate portion extending from the first end to the second end, and an inner surface defining a cavity configured to receive a lug of a vehicle wheel. The first ends of each of the at least two protrusions are disposed within a plane. The first curved region extends radially inwardly from a first location on each of the elongate portions of the at least two protrusions and towards the plane.

According to another aspect of the present disclosure, a powered vehicle wheel is provided. The powered vehicle comprises a vehicle wheel hub cover. The vehicle wheel hub cover comprises a first curved region and at least two protrusions radially disposed about a periphery of the curved region. Each of the at least two protrusions comprises a first end, a second end, an elongate portion extending from the first end to the second end, and an inner surface defining a cavity configured to receive a lug of a vehicle wheel. The first ends of each of the at least two protrusions are disposed within a plane. The first curved region extends radially inwardly from a first location on each of the elongate portions of the at least two protrusions and towards the plane. The vehicle wheel hub cover is configured to reduce aerodynamic drag of the powered vehicle and result in a reduced fuel consumption rate for the powered vehicle.

According to yet another aspect of the present disclosure, a method for reducing aerodynamic drag of a vehicle is provided. The method comprises mounting a vehicle wheel hub cover a vehicle wheel of the vehicle. The vehicle wheel hub cover comprises a first curved region and at least two protrusions radially disposed about a periphery of the curved region. Each of the at least two protrusions comprises a first end, a second end, an elongate portion extending from the first end to the second end, and an inner surface defining a cavity configured to receive a lug of a vehicle wheel. The first ends of each of the at least two protrusions are disposed within a plane. The first curved region extends radially inwardly from a first location on each of the elongate portions of the at least two protrusions and towards the plane.

It is understood that the inventions disclosed and described in this specification are not limited to the aspects summarized in this Summary. The reader will appreciate the foregoing details, as well as others, upon considering the following detailed description of various non-limiting and non-exhaustive aspects according to this specification.

### BRIEF DESCRIPTION OF THE DRAWINGS

The features and advantages of the examples, and the manner of attaining them, will become more apparent, and the examples will be better understood, by reference to the following description taken in conjunction with the accompanying drawings, wherein:

FIG. 1 is a front perspective view of a non-limiting embodiment of a vehicle wheel hub cover according to the present disclosure;

FIG. 2 is a rear perspective view of the vehicle wheel hub cover shown in FIG. 1;

FIG. 3 is cross sectional view of the vehicle wheel hub cover shown in FIG. 1 sectioned at line 3-3 in FIG. 1;

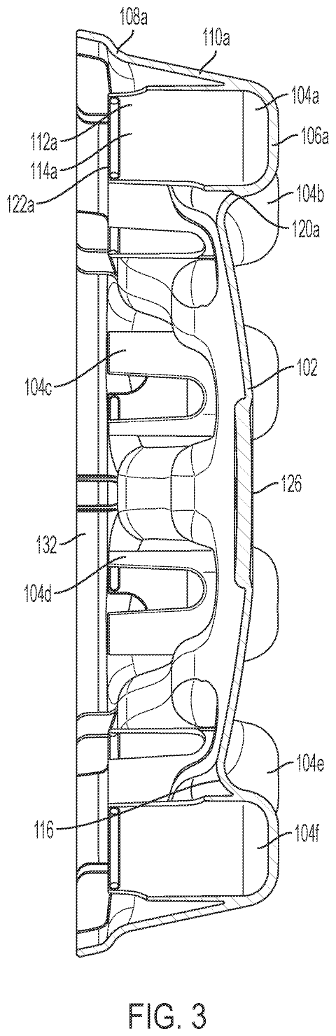

FIG. 4 is a cross sectional view of the vehicle wheel hub cover shown in FIG. 1 sectioned at line 4-4 in FIG. 1;

FIG. 5 is a non-limiting embodiment of a powered vehicle having the vehicle wheel hub cover of FIG. 1 installed thereon;

FIG. 6 is a flow chart illustrating a method comprising coupling a non-limiting embodiment of a vehicle wheel hub cover according to the present disclosure to a vehicle wheel; and

FIG. 7 is a computer simulation model of a non-limiting embodiment of aerodynamic fluid analysis of a powered vehicle with a vehicle wheel hub cover according to the present disclosure installed and a comparative powered vehicle with a comparative vehicle wheel hub cover installed.

Corresponding reference characters indicate corresponding parts throughout the several views. The exemplifications set out herein illustrate certain embodiments, in one form, and such exemplifications are not to be construed as limiting the scope of the appended claims in any manner.

### DETAILED DESCRIPTION

Various embodiments are described and illustrated herein to provide an overall understanding of the structure, function, and use of the disclosed articles and methods. The various embodiments described and illustrated herein are non-limiting and non-exhaustive. Thus, an invention is not limited by the description of the various non-limiting and non-exhaustive embodiments disclosed herein. Rather, the invention is defined solely by the claims. The features and characteristics illustrated and/or described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. The various embodiments disclosed and described in this specification can comprise, consist of, or consist essentially of the features and characteristics as variously described herein.

Any references herein to “various embodiments”, “some embodiments”, “one embodiment”, “an embodiment”, “a non-limiting embodiment”, or like phrases mean that a particular feature, structure, or characteristic described in connection with the example is included in at least one embodiment. Thus, appearances of the phrases “in various embodiments”, “in some embodiments”, “in one embodiment”, “in an embodiment”, “in a non-limiting embodiment”, or like phrases in the specification do not necessarily refer to the same embodiment. Furthermore, the particular described features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation. Such modifications and variations are intended to be included within the scope of the present embodiments.

As used herein, a referenced element or region that is “intermediate” two other elements or regions means that the referenced element/region is disposed between, but is not necessarily in contact with, the two other elements/regions. Accordingly, for example, a referenced element that is “intermediate” a first element and a second element may or may not be immediately adjacent to or in contact with the first and/or second elements, and other elements may be disposed between the referenced element and the first and/or second elements.

Vehicle wheels can be a source of aerodynamic drag for a powered vehicle and, thus, aerodynamic covers for vehicle wheels are commonly used to reduce the aerodynamic drag produced by the vehicle's wheels. Additionally, other regions of the powered vehicle, such as fenders, can be sources of aerodynamic drag. Typically, aerodynamic covers are assessed for aerodynamic efficiency in isolation, and aerodynamic drag of the full vehicle system, including aerodynamic drag produced by the installed aerodynamic covers and the fender, is not assessed. The inventors of the present disclosure surprisingly discovered that embodiments of a vehicle wheel hub cover according to the present disclosure can improve aerodynamic efficiency of a powered vehicle compared with the same vehicle outfitted with comparative wheel hub covers that may be more aerodynamically efficient when assessed in isolation. Embodiments of a vehicle wheel hub cover according to the present disclosure, for example, can direct air away from the vehicle's fenders, thereby further increasing aerodynamic efficiency of the vehicle.

Embodiments of a vehicle wheel hub cover according to the present disclosure comprise a first curved region and at least two protrusions radially disposed about a periphery of the curved region. Each of the at least two protrusions comprise a first end, a second end, an elongate portion extending from the first end to the second end, and an inner surface defining a cavity configured to receive a lug of a vehicle wheel. The first ends of each of the at least two protrusions can be disposed within a plane. The first curved region can extend radially inwardly from a first location on each of the elongate portions of the at least two protrusions and towards the plane.

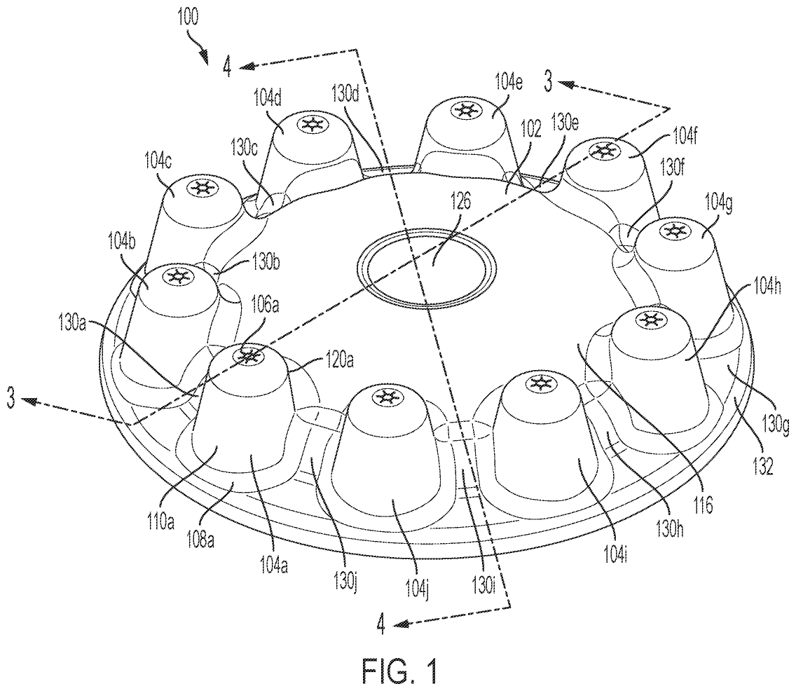

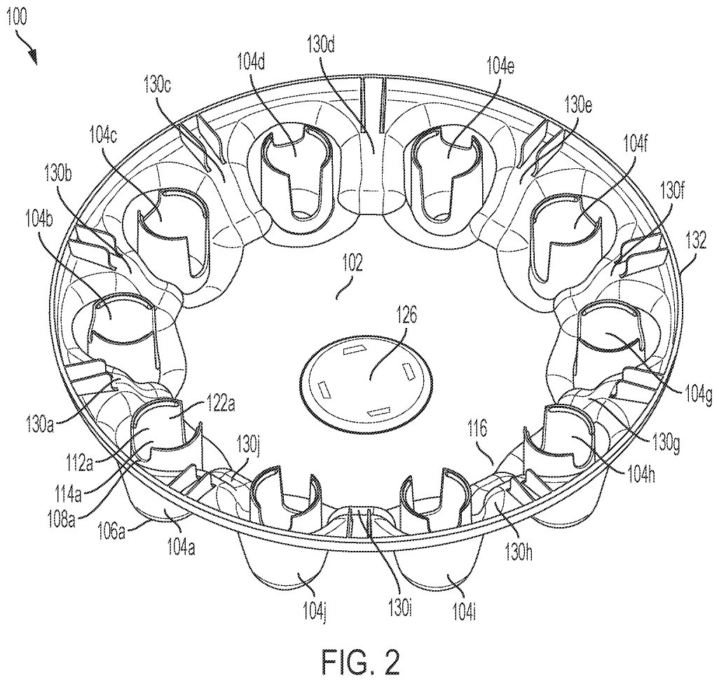

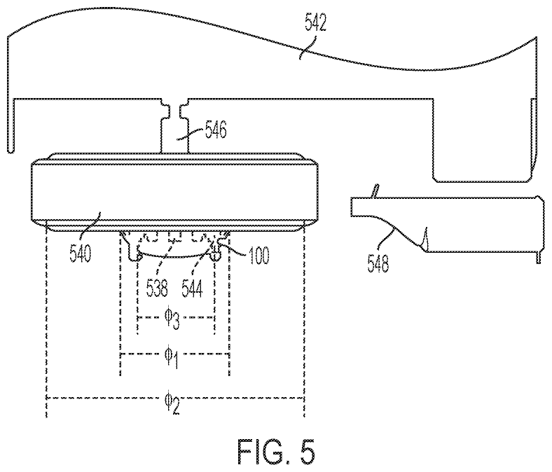

Referring to FIGS. 1 and 2, a non-limiting embodiment of a vehicle wheel hub cover 100 is shown. The vehicle wheel hub cover 100 can comprise a first curved region 102 and at least two protrusions radially disposed about a periphery 116 of the first curved region 102. For example, as illustrated in FIGS. 1 and 2, the vehicle wheel hub cover 100 can comprise ten protrusions 104a-104j spaced equally about the periphery 116 of the first curved region 102. In various other non-limiting embodiments, the vehicle wheel hub cover 100 can comprise eight protrusions (not shown) spaced equally about the periphery 116 of the first curved region 102. In certain other non-limiting embodiments, the vehicle wheel hub cover 100 can comprise a number of protrusions based on the desired application, spaced equally about the periphery 116 of the first curved region 102. In various non-limiting embodiments in which the vehicle wheel hub cover 100 is installed on a vehicle wheel of a powered vehicle (e.g., vehicle wheel 540 of a powered vehicle 542, illustrated in FIG. 5), the vehicle wheel hub cover 100 can reduce aerodynamic drag of the powered vehicle relative to the powered vehicle without the vehicle wheel hub cover 100 installed thereon.

Referring again to FIGS. 1 and 2, the protrusions 104a-104j will be described herein with reference to protrusion 104a. However, it is understood that protrusions 104b-104j can have a configuration that is substantially the same as, or is identical to, protrusion 104a. Protrusion 104a can comprise a first end 106a, a second end 108a, and an elongate portion 110a extending from the first end 106a to the second end 108a, and, as illustrated in FIG. 2, an inner surface 112a defining a cavity 114a configured to receive a lug of a vehicle wheel. For example, the inner surface 112a can extend from the second end 108a towards the first end 106a, and the inner surface 112a can be sized to create a friction fit between the inner surface 112a and a vehicle wheel lug nut received by the cavity 114a. The first end 106a can be closed and the second end 108a defines an opening 122a, which can receive the lug nut. In various non-limiting embodiments, the protrusion 104a can comprise a tubular shape such that the shape of the inner surface 112a substantially conforms to the lug nut shape. In certain non-limiting embodiments, the protrusion 104a comprises a frustoconical shape. In various embodiments, all of protrusions 104a-104j are configured so as to friction fit with a lug nut of the vehicle wheel when the vehicle wheel hub cover 100 is installed on the vehicle wheel. In various other embodiments, at least one but less than less than all of protrusions 104a-104j are configured so as to friction fit with a lug nut of the vehicle wheel when the vehicle wheel hub cover 100 is installed on the vehicle wheel.

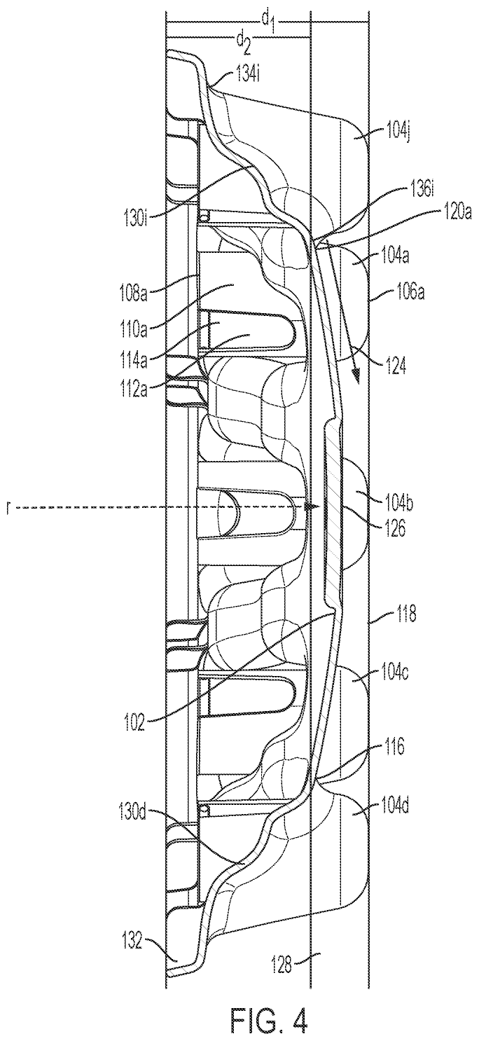

The first curved region 102 and the protrusions 104a-104j can be configured to reduce the aerodynamic drag of a powered vehicle when the vehicle wheel hub cover 100 is installed on the powered vehicle. As illustrated in the cross-sectional view in FIG. 4, the first ends (e.g., first end 106a of protrusion 104a) of each of the protrusions 104a-104j can be disposed within a plane 118 (i.e., an imaginary plane). As indicated by directional arrow 124 in FIG. 4, the first curved region 102 can extend radially inwardly from a first location (e.g. first location 120a on protrusion 104a) on each of the elongate portions (e.g., elongate portion 110a) of each protrusion 104a-104j and towards the plane 118. In various non-limiting embodiments, the first curved region 102 does not intersect the plane 118. For example, the first curved region 102 can be convex and disk-shaped, such that the first curved region 102 extends radially inwardly from the first location on the elongate portion 110 of each protrusion 104a-104j, along the first curved region 102, and towards an apex 126. The apex 126 can be positioned intermediate the plane 118 and a plane 128 defined by the first locations on the elongate portions of each protrusion 104a-104j. In various non-limiting embodiments, the first curved region 102 can define a radius of curvature, r, in a range of 5.00 inches (127 millimeters) to 50.00 inches (1270 millimeters), such as, for example, in a range of 20.00 inches (508 millimeters) to 35.00 inches (889 millimeters). The first curved region 102 can define a portion of a sphere and comprise a single radius of curvature or the first curved region can be a complex curve having at least two radii of curvature. In various non-limiting embodiments, the first curved region 102 comprises a spline that substantially follows a radius of curvature, r.

The positioning and/or size of the first curved region 102 relative to the protrusions 104a-104j can reduce the aerodynamic drag of a powered vehicle on which the vehicle wheel hub cover 100 is installed. The first curved region 102 can at least partially cover the protrusions 104a-104j but may not fully cover the protrusions 104a-104j such that the protrusions 104a-104j can enhance the aerodynamics of a powered vehicle on which the vehicle wheel hub cover 100 is installed. Referring again to FIG. 4, a first distance, d₁, separates the first end 106a and the second end 108a, and a second distance, d₂, separates the first location 120a and the second end 108a. In various non-limiting embodiments, the second distance, d₂, can be in a range of 20% to 95% of the first distance, d₁, such as, for example, a range of 25% to 90% of the first distance, d₁; a range of 30% to 90% of the first distance, d₁; a range of 35% to 90% of the first distance, d₁; a range of 40% to 90% of the first distance, d₁; a range of 45% to 90% of the first distance, d₁; a range of 50% to 90% of the first distance, d₁; a range of 50% to 85% of the first distance, d₁; a range of 55% to 85% of the first distance, d₁; a range of 55% to 80% of the first distance, d₁; or a range of 60% to 80% of the first distance, d₁.

According to various non-limiting embodiments, the vehicle wheel hub cover 100 can comprise at least two second curved regions, and each second curved region can be disposed intermediate two of the protrusions 104a-104j and about the periphery 116 of the first curved region 102. For example, as illustrated in FIGS. 1 and 2, the vehicle wheel hub cover 100 can comprise ten second curved regions 130a-130j, and each second curved region 130a-130j can be disposed intermediate two of protrusions 104a-104j and equally spaced about the periphery 116 of the first curved region 102. In various non-limiting embodiments in which the vehicle wheel hub cover 100 comprises eight protrusions, the vehicle wheel hub cover 100 can comprise eight second curved regions (not shown), and each second curved region can be disposed intermediate two of the eight protrusions and spaced equally about the periphery 116 of the first curved region 102. In certain non-limiting embodiments, the vehicle wheel hub cover 100 can comprise a number of second curved regions based on the number of protrusions defined by the vehicle wheel hub cover 100 such that one second curved region is defined between each two adjacent protrusions 104a-104j.

The second curved regions 130a-130j can enhance the aerodynamics (i.e. reduce the aerodynamic drag) of a powered vehicle on which the vehicle wheel hub cover 100 is installed. For example, the second curved regions 130a-130j can provide a “ramp” for air flowing between two adjacent protrusions 104a-104j and to the first curved region 102.

The vehicle wheel hub cover 100 can comprise an annular region 132 abutting the second end (e.g., 108a) of each of the protrusions 104a-104j. The second curved regions 130a-130j can extend from the annular region 132 to the first curved region 102. As illustrated in FIG. 4, and referring to the second curved region 130i as an example, the second curved region 130i can start at a second location 134i on the annular region 132 and end at a third location 136i on the first curved region 102 in the plane 128. Curved regions 130a-130h and 130j can be configured substantially the same as, or identical to, the second curved region 130i.

Referring to FIG. 5, the vehicle wheel hub cover 100 can be configured to attach over a hub 538 of a vehicle wheel 540 of a powered vehicle 542. When installed in this way, the vehicle wheel hub cover 100 can cover the lug nuts 544 used to secure the vehicle wheel 540 to the vehicle axle 546 of the powered vehicle 542. The first curved region 102 and each of the at least two protrusions 104a-104j can comprise shapes that reduce aerodynamic drag of the powered vehicle 542 when the vehicle wheel hub cover 100 is installed on a vehicle wheel 540 of the powered vehicle 542 by, for example, directing air around a fender 548 of the powered vehicle 542. The reduced aerodynamic drag of the powered vehicle 542 can result in a reduced fuel consumption rate of the powered vehicle 542. For example, during operation of a hydrocarbon fuel-powered vehicle, the vehicle wheel hub cover 100 can reduce aerodynamic drag of the powered vehicle, resulting in increased hydrocarbon fuel mileage (e.g., miles per gallon) for the powered vehicle. In situations in which the vehicle wheel hub cover 100 is installed on an electrically powered vehicle, the resultant reduced aerodynamic drag that can be achieved with the vehicle wheel hub cover 100 may increase, for example, the distance the vehicle can travel on a single vehicle battery charge and/or increase the miles per gallon gasoline equivalent (MPGe) of the vehicle.

A vehicle wheel hub cover according to the present disclosure can be configured to be installed on a variety of wheeled vehicles. For example, the powered vehicle 542 can comprise a vehicle weight class in a range of 1 to 8, such as, for example, 3 to 8, as defined by the U.S. Federal Highway Administration. For example, in various non-limiting embodiments the gross weight of the powered vehicle 542 can be at least 10,001 lbs. (4536.48 kg) or at least 26,000 lbs. (11,798.4 kg). The powered vehicle 542 can be, for example, a light-duty, medium-duty, or heavy-duty vehicle. In various non-limiting embodiments, the powered vehicle 542 can be a truck (e.g., pick-up, full-sized, tractor (e.g., semi-truck)), a van, or a bus. The powered vehicle 542 can comprise at least two axles, such as, for example, at least three axles, at least four axles, at least five axles, or at least six axles. In various non-limiting embodiments, the powered vehicle 542 can comprise no greater than ten axles such as, for example, no greater than six axles, no greater than five axles, no greater than four axles, or no greater than three axles. In various non-limiting embodiments, the powered vehicle 542 can comprise a number of axles in a range of two to ten. In various non-limiting embodiments, the powered vehicle 542 can be powered by a combustion engine, one or more electric motors, or a combination thereof.

In various embodiments, the vehicle wheel hub cover 100 can comprise a first diameter, ϕ1, and can be configured to mount on the vehicle wheel 540 (e.g., a steer wheel of a semi-truck) comprising a second diameter, ϕ2. The second diameter, ϕ2, can be greater than the first diameter, ϕ1. Bores in the vehicle wheel 540 can be configured to receive studs of a vehicle axle 546. The bores can form a mounting circle (i.e., imaginary circle) which can comprise a third diameter, ϕ3, and the first diameter, ϕ1, can be greater than the third diameter, ϕ3.

In various non-limiting embodiments, the vehicle wheel 540 can comprise a nominal rim diameter in a range of 1 inch (2.54 mm) to 200 inches (5080 mm), such as, for example, 14 inches (406.4 mm) to 25 inches (635 mm), or 19 inches (482.6 mm) to 25 inches (635 mm). In various non-limiting embodiments, the vehicle wheel 540 can comprise a nominal rim width in a range of 1 inch (2.54 mm) to 100 inches (2540 mm), such as, for example, 6 inches (152.4 mm) to 24 inches (609.6 mm), or 6 inches (152.4 mm) to 12 inches (304.8 mm).

In various non-limiting embodiments, the vehicle wheel hub cover 100 can comprise a polymer, a metal, a metal alloy, or a combination of two or more of those materials. In various non-limiting embodiments, the vehicle wheel hub cover 100 can comprise rigid materials.

The vehicle wheel hub cover 100 can be formed by various methods. For example, the vehicle wheel hub cover 100 can be injection molded and can comprise a substantially similar wall thickness throughout the vehicle wheel hub cover 100 that is suitable for injection molding. In various non-limiting embodiments, the first curved region 102 and the protrusions 104a-104j are integrally formed. In certain non-limiting embodiments, the annular region 132, the second curved regions 130a-130j, the first curved region 102, and the protrusions 104a-104j are integrally formed such that the vehicle wheel hub cover 100 is a single piece. In other non-limiting embodiments, the vehicle wheel hub cover 100 can be formed such that is comprises at least two pieces that are assembled together to form the vehicle wheel hub cover 100.

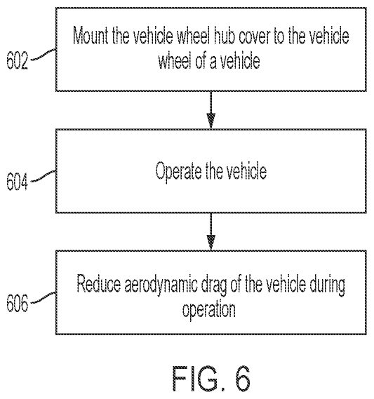

Referring to FIG. 6, the present disclosure also provides a method for reducing aerodynamic drag of a powered vehicle. The method comprises mounting a vehicle wheel hub cover according to the present disclosure (such as vehicle wheel hub cover 100) to a vehicle wheel of a powered vehicle at step 602. The vehicle wheel may be attached to an axle of the powered vehicle, such as, for example, a steer axle, a drive axle, or a trailer axle of the powered vehicle. For example, the vehicle wheel hub cover 100 can be attached to a steer wheel or a trailer axle of a semi-truck. The method can comprise operating the vehicle, including rotating the vehicle wheel on which the vehicle wheel hub cover 100 is installed, at step 604. The method can comprise reducing aerodynamic drag of the vehicle during operation such that less hydrocarbon fuel can be consumed per unit distance traveled, less battery power can be consumed per unit distance traveled, or a combination thereof (relative to the vehicle without the vehicle wheel hub cover 100 installed thereon), at step 606.

### Examples

The present disclosure will be more fully understood by reference to the following examples, which provide various non-limiting aspects of the invention. It is understood that the invention described in this specification is not necessarily limited to the examples described in this section.

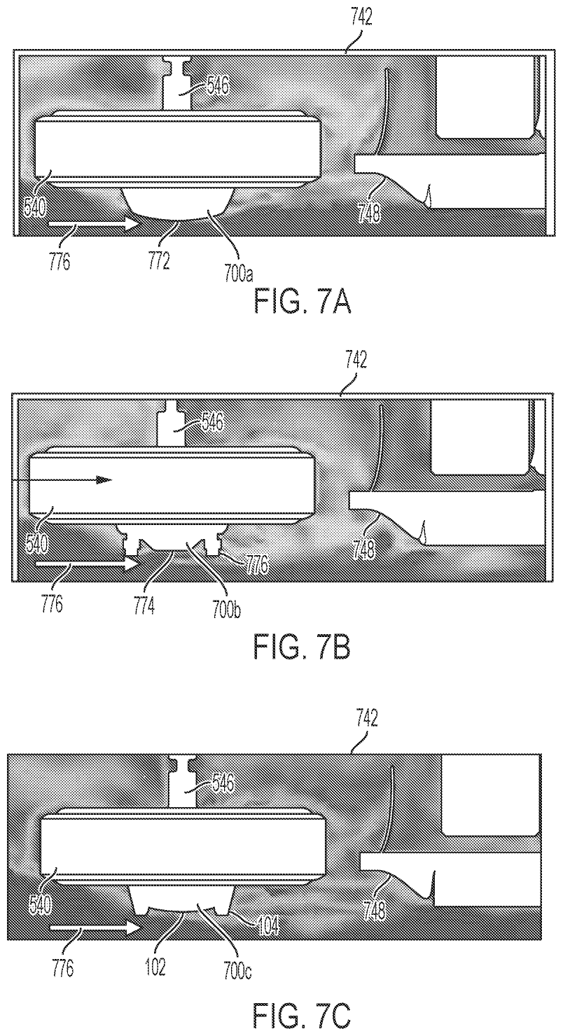

Referring to FIGS. 7A-7B, in order to illustrate the advantageous aerodynamic drag reduction according to the present disclosure, a 3D model of a first comparative hub cover 700a and a 3D model of a second comparative hub cover 700b were obtained. The first comparative hub cover 700a comprises a single curved region 772 without any protrusions and the second comparative hub cover 700b comprises a curved region 774 and ten protrusions 776 spaced equally around a periphery 778 of the curved region 774. The single curved region 772 does not extend from an elongate portion of the protrusions 776. Additionally, referring to FIG. 7C, a 3D model of a vehicle wheel hub cover 700c according to the present disclosure comprising a first curved region 102 and ten protrusions 104 was obtained. Referring to FIGS. 7A-C the 3D models of the first comparative hub cover 700a, the second comparative hub cover 700b, and the vehicle wheel hub cover 700c according to the present disclosure were placed on a 3D model of a semi-truck 742 and associated trailer and tested for computational fluid dynamics (CFD). The configuration of the CFD model for the semi-truck 742 and associated trailer were according to EPA standards at 4.5 degrees yaw. The yaw configuration is the same as used by the EPA for GHG2 approval and has shown to be a close approximation to a drag coefficient at 65 mph.

It was observed that based on the CFD analysis shown in FIGS. 7A-7C, the first comparative hub cover 700a and the second comparative hub cover 700b did not substantially change the overall drag coefficient of the semi-truck 742 and the trailer. However, the vehicle wheel hub cover 700c according to the present disclosure had an at least 75% improvement in overall drag reduction of the semi-truck 742 based on the first comparative hub cover 700a and the second comparative hub cover 700b. Without being bound to any particular theory, it is believed that the first comparative hub cover 700a has a shape which pulls high energy air flow in behind the vehicle wheel 540 and thereby contacts the fender 748 of the semi-truck 742 and the second comparative hub cover 700b creates a large amount of air turbulence that pushes the high energy air flow too far away from the fender 748, thereby upsetting an aerodynamically favorable attachment of the high energy air flow to the fender 748. Without being bound to any particular theory, it is believed that since the first curved region 102 protrudes away from the vehicle wheel 540 less than the protrusions 104, turbulence is created to a sufficient degree to fill a gap between the vehicle wheel 540 and the fender 748 with the turbulent flow such that the high energy air flow is minimally, if at all, pulled in behind the vehicle wheel 540. Additionally, it is believed that since the first curved region 102 extends radially inwardly from the elongate portion of the protrusions 104, the turbulent flow is created to a sufficient degree such that high energy air flow is not pushed too far away from the fender 748. As a result, aerodynamically favorable attachment of high energy air flow to the fender 748 is achieved. Accordingly, the vehicle wheel hub cover 700c can reduce aerodynamic drag of the semi-truck 742 which can result in a reduced fuel consumption rate for the semi-truck 742.

Various aspects of the invention include, but are not limited to, the aspects listed in the following numbered clauses.
Clause 1. A vehicle wheel hub cover comprising:
   a first curved region; and
   at least two protrusions radially disposed about a periphery of the first curved region, each of the at least two protrusions comprising a first end, a second end, an elongate portion extending from the first end to the second end, and an inner surface defining a cavity configured to receive a lug of a vehicle wheel, wherein the first ends of each of the at least two protrusions are disposed within a plane;
   wherein the first curved region extends radially inwardly from a first location on each of the elongate portions of the at least two protrusions and towards the plane.
Clause 2. The vehicle wheel hub cover of clause 1, wherein the first curved region does not intersect the plane.
Clause 3. The vehicle wheel hub cover of any of clauses 1-2, wherein the first curved region is convex.
Clause 4. The vehicle wheel hub cover of any of clauses 1-3, wherein the first curved region and each of the at least two protrusions are integrally formed.
Clause 5. The vehicle wheel hub cover of any of clauses 1-4, wherein on each of the at least two protrusions, a first distance separates the first end and the second end, a second distance separates the first location and the second end, and the second distance is in a range of 20% to 95% of the first distance.
Clause 6. The vehicle wheel hub cover of clause 5, wherein the second distance is in a range of 40% to 90% of the first distance.
Clause 7. The vehicle wheel hub cover of clause 5, wherein the second distance is in a range of 60% to 80% of the first distance.
Clause 8. The vehicle wheel hub cover of any one of clauses 1-7, wherein each of the at least two protrusions comprises a tubular shape, each first end is closed, and each second end defines an opening.
Clause 9. The vehicle wheel hub cover of any of clauses 1-8, wherein each of the at least two protrusions comprises a frustoconical shape.
Clause 10. The vehicle wheel hub cover of any of clauses 1-9, further comprising at least two second curved regions, each second curved region disposed intermediate two of the at least two protrusions and about the periphery of the first curved region.
Clause 11. The vehicle wheel hub cover of clause 10, further comprising an annular region abutting the second end of each of the at least two protrusions.
Clause 12. The vehicle wheel hub cover of clause 11, wherein each of the at least two second curved regions extends from the annular region to the first curved region.
Clause 13. The vehicle wheel hub cover of any one of clauses 1-12, wherein the vehicle wheel hub cover comprises a first diameter and is configured to mount on a vehicle wheel comprising a second diameter that is greater than the first diameter.
Clause 14. The vehicle wheel hub cover of any one of clauses 1-13, wherein the vehicle wheel hub cover comprises a first diameter and is configured to mount on a vehicle wheel, a mounting circle formed by bores in the vehicle wheel configured to receive studs of a vehicle axle comprises a second diameter, and the first diameter is greater than the second diameter.
Clause 15. The vehicle wheel hub cover of any one of clauses 1-14, wherein the vehicle wheel hub cover comprises eight protrusions spaced equally about the periphery of the first curved region or ten protrusions spaced equally about the periphery of the first curved region.
Clause 16. The vehicle wheel hub cover of any one of clauses 1-15, wherein, when the vehicle wheel hub cover is mounted on a vehicle wheel of a powered vehicle, the first curved region and each of the at least two protrusions comprises a shape that reduces aerodynamic drag of the powered vehicle.
Clause 17. The vehicle wheel hub cover of any one of clauses 1-16, wherein the vehicle wheel hub cover is configured to mount on a vehicle wheel comprising a nominal rim diameter in a range of 1 inch to 200 inches and a nominal rim width in a range of 1 inch to 100 inches.
Clause 18. The vehicle wheel hub cover of any one of clauses 1-17, wherein the vehicle wheel hub cover is configured to mount on a steer wheel of a semi-truck.
Clause 19. A powered vehicle comprising a vehicle wheel hub cover as recited in any one of clauses 1-18 mounted on a vehicle wheel of the powered vehicle, wherein the vehicle wheel hub cover is configured to reduce aerodynamic drag of the powered vehicle and result in a reduced fuel consumption rate for the powered vehicle.
Clause 20. A method for reducing aerodynamic drag of a vehicle, the method comprising mounting a vehicle wheel hub cover as recited in any one of clauses 1-18 to a vehicle wheel of the vehicle.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Also, all ranges recited herein are inclusive of the end points of the recited ranges. For example, a range of “1 to 10” includes the end points 1 and 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The grammatical articles “a,” “an,” and “the,” as used herein, are intended to include “at least one” or “one or more,” unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural and the use of a plural noun includes the singular, unless the context of the usage requires otherwise.

One skilled in the art will recognize that the herein described articles and methods, and the discussion accompanying them, are used as examples for the sake of conceptual clarity and that various configuration modifications are contemplated. Consequently, as used herein, the specific examples/embodiments set forth and the accompanying discussion are intended to be representative of their more general classes. In general, use of any specific exemplar is intended to be representative of its class, and the non-inclusion of specific components, devices, operations/actions, and objects should not be taken to be limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

What is claimed is:

1. A vehicle wheel hub cover comprising:
a first curved region; and
at least two protrusions radially disposed about a periphery of the first curved region, each of the at least two protrusions comprising a first end, a second end, an elongate portion extending from the first end to the second end, and an inner surface defining a cavity configured to receive a lug of a vehicle wheel, wherein the first ends of each of the at least two protrusions are disposed within a plane;
wherein the first curved region extends radially inwardly from a first location on each of the elongate portions of the at least two protrusions and towards the plane.

2. The vehicle wheel hub cover of claim 1, wherein the first curved region does not intersect the plane.

3. The vehicle wheel hub cover of claim 1, wherein the first curved region is convex.

4. The vehicle wheel hub cover of claim 1, wherein the first curved region and each of the at least two protrusions are integrally formed.

5. The vehicle wheel hub cover of claim 1, wherein on each of the at least two protrusions, a first distance separates the first end and the second end, a second distance separates the first location and the second end, and the second distance is in a range of 20% to 95% of the first distance.

6. The vehicle wheel hub cover of claim 5, wherein the second distance is in a range of 40% to 90% of the first distance.

7. The vehicle wheel hub cover of claim 5, wherein the second distance is in a range of 60% to 80% of the first distance.

8. The vehicle wheel hub cover of claim 1, wherein each of the at least two protrusions comprises a tubular shape, each first end is closed, and each second end defines an opening.

9. The vehicle wheel hub cover of claim 1, wherein each of the at least two protrusions comprises a frustoconical shape.

10. The vehicle wheel hub cover of claim 1, further comprising at least two second curved regions, each second curved region disposed intermediate two of the at least two protrusions and about the periphery of the first curved region.

11. The vehicle wheel hub cover of claim 10, further comprising an annular region abutting the second end of each of the at least two protrusions.

12. The vehicle wheel hub cover of claim 11, wherein each of the at least two second curved regions extends from the annular region to the first curved region.

13. The vehicle wheel hub cover of claim 1, wherein the vehicle wheel hub cover comprises a first diameter and is configured to mount on a vehicle wheel comprising a second diameter that is greater than the first diameter.

14. The vehicle wheel hub cover of claim 1, wherein the vehicle wheel hub cover comprises a first diameter and is configured to mount on a vehicle wheel, a mounting circle formed by bores in the vehicle wheel configured to receive studs of a vehicle axle comprises a second diameter, and the first diameter is greater than the second diameter.

15. The vehicle wheel hub cover of claim 1, wherein the vehicle wheel hub cover comprises eight protrusions spaced equally about the periphery of the first curved region or ten protrusions spaced equally about the periphery of the first curved region.

16. The vehicle wheel hub cover of claim 1, wherein, when the vehicle wheel hub cover is mounted on a vehicle wheel of a powered vehicle, the first curved region and each of the at least two protrusions comprises a shape that reduces aerodynamic drag of the powered vehicle.

17. The vehicle wheel hub cover of claim 1, wherein the vehicle wheel hub cover is configured to mount on a vehicle wheel comprising a nominal rim diameter in a range of 1 inch to 200 inches and a nominal rim width in a range of 1 inch to 100 inches.

18. The vehicle wheel hub cover of claim 1, wherein the vehicle wheel hub cover is configured to mount on a steer wheel of a semi-truck.

19. A powered vehicle comprising a vehicle wheel hub cover as recited in claim 1 mounted on a vehicle wheel of the powered vehicle, wherein the vehicle wheel hub cover is configured to reduce aerodynamic drag of the powered vehicle and result in a reduced fuel consumption rate for the powered vehicle.

20. A method for reducing aerodynamic drag of a vehicle, the method comprising mounting a vehicle wheel hub cover as recited in claim 1 to a vehicle wheel of the vehicle.
